(19) United States
(12) Patent Application Publication
(10) Pub. No.: US 2025/0012258 A1
(43) Pub. Date: Jan. 9, 2025

(54) METHOD FOR CLEANING A GENERATOR OF A WIND TURBINE

(71) Applicant: Siemens Gamesa Renewable Energy A/S, Brande (DK)

(72) Inventors: Rifat Celiloglu, Vejle (DK); Anders Saaby Toft, Horsens (DK)

(21) Appl. No.: 18/763,271

(22) Filed: Jul. 3, 2024

(30) Foreign Application Priority Data
Jul. 5, 2023 (EP) 23183670.1

(51) Int. Cl. F03D 80/55; B08B 5/04; B08B 9/00; C11D 7/50; F03D 9/25; H02K 7/18

(52) U.S. Cl. CPC F03D 80/55; B08B 5/04; B08B 9/00; C11D 7/5027; F03D 9/255; H02K 7/183; F05B 2220/706

(57) ABSTRACT

A method for cleaning a generator of a wind turbine is provided, including locking a wind turbine rotor, shutting off a generator; removing a cooling device such that an opening is accessible for maintenance purposes; inserting a cleaning agent into the opening such that the cleaning agent gets at least partially in effective contact with a winding and/or with a magnetic element; at least partially removing the cleaning agent from the generator; mounting the cooling device to the opening; and releasing the wind turbine rotor, wherein the cleaning agent is or includes a grease remover that is non-water-soluble and a fluid liquid such that the generator can be partially flushed with the grease remover, has a density larger than 0.6 g/cm³ and lower than 0.85 g/cm³, has kinematic viscosity larger than 1.3 mm²/s and lower than 2.5 mm²/s, and comprises N-Paraffins and hydrocarbons.

### CROSS-REFERENCE TO RELATED APPLICATIONS

This application claims priority to EP application Ser. No. 23/183,670.1, having a filing date of Jul. 5, 2023, the entire contents of which are hereby incorporated by reference.

### FIELD OF TECHNOLOGY

The following relates to a method for cleaning a generator of a wind turbine, to a method for operating a wind turbine, to a wind turbine, and to a use of a cleaning agent for cleaning a wind turbine.

### BACKGROUND

Generators in wind turbines are facing a grease leakage issue which is sourced by the main bearing of the generator. The leaking grease from the main bearing seals finds its way into the generator that cannot be reached by cleaning apparatuses since the space within the generator housing is very limited.

Against this background, it is a problem to be solved by embodiments of the present invention to provide for a possibility to clean a generator, in particular the stator windings of a generator in a wind turbine from grease.

### SUMMARY

According to an aspect, the wind turbine having a generator to be cleaned comprises a tower, a nacelle rotatably mounted to the tower, a wind turbine rotor with at least one rotor blade, the wind turbine rotor being rotatably mounted to the nacelle around an essentially horizontal rotational axis, and an electric generator drivable by the wind turbine rotor.

According to an embodiment, the generator comprises a fixed housing and a rotating housing, a generator rotor having magnetic elements, a stator having windings, and a cooling device attached to an opening of the fixed housing. In embodiments, according to this embodiment the stator is encompassed or surrounded by the generator rotor, wherein the stator is equipped with a plurality of windings. The generator rotor is rotatably connected to the wind turbine rotor such that a rotation of the wind turbine rotor is transmitted on the generator rotor. In embodiments, the rotating housing of the generator is rotatably connected to the wind turbine rotor while supporting on a radial inner side a plurality of magnetic elements. The configuration of the generator rotor and the stator is chosen such that only a smaller airgap in radial direction is in between a winding of the stator and a magnetic element of the rotor. Furthermore, the generator comprises a cooling device which is attached to an opening of a fixed portion of the housing (fixed housing).

According to an embodiment/aspect the configuration of the generator may be different, for example such that the rotor of the generator is encompassed by the stator of the generator, while the rotor comprises at least one magnetic element, wherein the stator comprises at least one winding.

If the generator is driven by the wind turbine rotor, a relative translational/rotational movement between magnetic elements and windings of the generator is generated. By this an electric current is induced in the windings.

According to an aspect, in particular for cleaning a wind turbine having a configuration as described, the problem is solved by providing a method for cleaning the generator. The method comprising the steps of locking the wind turbine rotor and shutting off the generator. Then, the cooling device is removed such that the opening when the fixed housing is accessible for maintenance purposes. By providing this access opening the following step is enabled without having the necessity to create an additional opening in the housing of the generator and thereby inflicting structural harm to the generator. Subsequently, exceeding agent is inserted or poured into the opening such that the cleaning agent gets at least partially in effective contact with a winding and/or with a magnetic element. The cleaning agent then starts to act on the dirt, grease, or other substances being unwantedly present on the surface of a part of the generator, in particular on the sensible windings of the stator. After this, the cleaning agent is removed from the inside of the generator. Now, the cooling device is mounted again onto the opening of the housing, thereby closing the housing. The wind turbine can now resume its operation after having released the wind turbine rotor.

By conducting the method as described, for the first time a drastic technical prejudice is overcome, namely, to insert a cleaning agent into an inner volume of a generator. Usually, the skilled person would refrain from inserting a cleaning agent into an inner volume of the generators due to the presence of highly sensible surfaces, for example surfaces of the windings of the stator. By executing a vast series of elaborated tests and experiments a unique solution was identified by the inventing engineers that a specific cleaning agent having a unique composition is indeed suitable—in contrast to all understanding of the conventional art. Surprisingly, it has been found out that inserting a cleaning agent into the generator is successful for removing dirt or grease from surfaces of the stator or generator rotor, wherein the cleaning agent is or comprises a grease remover, and wherein the grease remover is a non-waters-soluble and is a fluid liquid such that the generator of the wind turbine can be partially flushed with the grease remover, has a density larger than 0.6 g/cm³ and lower than 0.85 g/cm³, has kinematic viscosity larger than 1.3 mm²/s and lower than 2.5 mm²/s, and comprises N-Paraffins and hydrocarbons.

The identification of the suitability of the specific cleaning agent required a remarkable investment in research and development, since the majority of tested cleaning agents shows to be unsuitable, ineffective, or even harmful to components of the generator. exclusively, the cleaning agent having the properties as described above succeeded in fulfilling various requirements of application.

The Term “in effective contact” may be understood such that a physical contact between the cleaning agent and a surface-possibly being partially covered with dirt, grease, or other substances being unwantedly present on the surface of the segment—is realized and the cleaning, solving, and removing effect of the cleaning agent can take place.

The cleaning agent may stay in effective contact with the respective segment or may remain within the generator for a given cleaning time to take effect. The given cleaning time is defined between the moment of first application of the cleaning agent and start of the removal step. The giving cleaning time is at least three minutes, at least five minutes, at least 10 minutes at least 15 minutes, and or is not more than 60 minutes, not more than 30 minutes, not more than 20 minutes.

Furthermore, the cleaning agent may be inserted into the generator or onto a surface of the inner volume of the generator such that a kinetic energy of a spray of the cleaning agent serves for properly distributing the cleaning agent over a majority of the relevant surfaces, in particular over the windings of the stator.

Additionally, or alternatively, the cleaning agent may be inserted into the generator or onto a respective surface by using a spray-device for inserting the cleaning agent configured such that a sharp and compact spray, compact of cleaning agent can be provided. The term “sharp and compact spray” may be understood such, that the spray has a spray opening-angle of not more than 90°, not more than 70°, not more than 45°, not more than 20°. In embodiments, the sharp and compact spray is configured such, that both is achieved, namely, covering a broader surface to be cleaned and applying a certain kinetic energy into the sprayed cleaning agent.

As a next subsequent step, the contaminated cleaning agent is removed from the generator. That means, at least a significant portion of the cleaning agent is taken away from a respective surface of the inner volume of the generator, is removed from the inside of the generator, and/or is sucked out of an inner volume of the generator such, that a normal standard functionality of the generator can be resumed. That means, a certain amount of residual cleaning agent not negatively inflicting with the functionality of the generator may remain in the inside of the generator such, that a test for the presence of the remaining cleaning agent is positive even after conducting the step of removing the cleaning agent from the generator. In embodiments, the step of removing the cleaning agent may comprise that at least 80%, at least 90%, at least 95%, at least 97%, or that at least 99% of the initially provided cleaning agent is removed from the inside of the generator. A status as described, namely that the cleaning agent is at least partially removed, can be determined as “the generator being cleaned”.

In a next step, the rotor is released from a temporary rotor lock for being able to rotate. The rotor is subsequently rotated such that another portion of the generator rotor can be cleaned. Cleaning of the other portion comprises locking the rotor again, inserting a cleaning agent into the generator or into the housing such that the cleaning agent is at least partially in effective contact with the other portion, and removing or at least partially removing the cleaning agent from the other portion of the generator. This process of cleaning may be continued and/or repeated until the entirety of the generator, e.g., all portions of the generator rotor are cleaned.

In the context of the present disclosure, shutting off a generator may involve disconnecting electrical connections by tripping/opening the circuit breakers between the generator and a rest of the turbine, such that the generator is free from electricity. Thus, starting the generator may involve connecting the electrical connection by closing opened circuit breakers between the generator and the wind turbine, such that the generator generates electrical energy, i.e., converts wind energy into electrical energy.

For shutting off the generator, the generator may be brought into a so-called LOTO state.

In the context of the present disclosure, idling or moving the rotor of a wind turbine means to circle the rotor without generating electrical energy for a distance, such as a length of a segment of the generator, for example. Thus, the rotor may be moved for a distance that equals 360° divided by a number of portions of the rotor.

In the context of the present disclosure, locking a rotor of a wind turbine prevents the rotor from moving. This locking may be caused by blocking a gear connected to the rotor or by engaging a brake connected to the rotor, for example.

Accordingly, the cleaning agent may be fed into the generator at a first point within the generator and removed at a second point within the generator, wherein the first point is higher in a direction of gravity than the second point. Alternatively, or additionally, the cleaning agent may be removed from the segment using a vacuum pump. Thus, by using gravity and/or vacuum, a force is applied that urges the cleaning agent through the segment, such that the cleaning agent comes in contact with grease accumulated inside generator, dissolves it, absorbs it and transports it out of the generator.

In embodiments, the use of vacuum allows the cleaning agent to be almost completely removed from the generator, preventing the release of cleaning agent into the environment.

By moving the rotor and/or the generator, the cleaning process can be repeated for another portion of the generator rotor. To move the rotor, a brake on the rotor is released, allowing the rotor to rotate, e.g., using gravity and/or wind energy. Alternatively, the rotor may be moved using a motor or muscle power of a technician.

According to an embodiment, before removing or at least partially removing the cleaning agent from the segment of the generator, the rotor is moved in at least one direction.

It has been found that moving, in particular idling the rotor moves the generator together with the cleaning agent inside the generator. This movement causes mechanical stress between the cleaning agent and the generator, which causes rubbing off grease from the generator. In embodiments, this movement urges the cleaning agent to non-accessible areas of the generator and dilutes grease in order for the grease to run off to more accessible areas.

The rotor may be moved for a time between 1 second and 12 hours, for example.

It has been surprisingly found in an experimental procedure that the cleaning agent which is in a liquid state or becomes at least partially liquid during cleaning, does not cause any damage to the generator and, further, removes grease from the generator reliably.

In the context of embodiments of the invention, it is to be mentioned that the single steps of the disclosed method are not necessarily required to be executed in the order as laid out; however, it is a favorable embodiment to execute those steps in the mentioned order.

According to an embodiment, the removed, contaminated cleaning agent is analyzed with respect to a criterion specifying the grade of contamination of the cleaning agent, and in case the grade of contamination is greater than a given threshold, the following steps are repeated until the grade of contamination is less or equal to the threshold: filling a fresh cleaning agent into the generator and removing the contaminated cleaning agent from the generator.

Using a criterion specifying the grade of contamination of the cleaning agent provides for an objective measure to evaluate whether the cleaning is fully contaminated and needs to be replaced or the cleaning agent is not fully contaminated, and the generator is clean.

Analyzing the cleaning agent with respect to the criterion specifying the grade of contamination of the cleaning agent may involve an optical inspection by eye or by using a spectrometer, for example.

According to an embodiment, the criterion comprises a reference color.

By using a reference color as a criterion specifying the grade of contamination of the cleaning agent, the contaminated cleaning agent can be evaluated easy and fast also in harsh conditions, such as in the nacelle of a wind turbine. Thus, by comparing the color of a contaminated cleaning agent with a reference color, the state of the contaminated cleaning agent and, therefore, the state of the generator can easily be assessed.

According to an embodiment, shutting off the generator comprises disconnecting an electrical connection between the generator and the rest of the turbine.

By disconnecting the electrical connection between the generator and the rest of the turbine, it is ensured that no interaction between electrical energy in the generator and the cleaning agent is generated, which may damage the generator.

According to an embodiment, the method further comprises shutting off a cooling system for cooling the generator before filling fresh cleaning agent into the generator and starting the cooling system before starting the generator for drying the generator from the cleaning agent.

Since the cooling system, such as a number of fans, for example, are driven electrically, the cooling system should be shut off, in particular be brought into a LOTO state, in order to ensure that no electricity is induced from the cooling system into the cleaning agent.

By starting the cooling system before starting up the generator as such, a stream of air provided by the cooling system may be used for drying the generator from a rest of the cleaning agent inside the generator. Since the cooling system provides only a small amount of heat, the generator is not critically warmed up.

According to an embodiment, removing the contaminated cleaning agent from the generator comprises lowering a suction hose into a housing of the generator, and sucking out the contaminated cleaning agent using a pump.

By using a hose, the hose can be lowered to a point at which the grease accumulates, such as the lowest point in the generator, for example. Of course, multiple points inside the generator may be used for sucking out contaminated cleaning agent.

A pump may be used for sucking out the contaminated cleaning agent, such as a pump driven by a driller, which is easy to handle and can by driven by electrical power from a battery.

According to an embodiment, the fresh cleaning agent is filled into the generator through the opening in the fixed housing of the generator.

By using the opening from the inside of the nacelle of the wind turbine for filling the cleaning agent into the generator, dangerous operations outside of the nacelle can be avoided. The opening may be a hatch for maintenance of the generator.

According to an embodiment, the volume of cleaning agent filled in the generator is between 10 and 200 liters, in particular 15 and 100 liters, between 20 and 80 liters, between 30 and 50 liters.

It has been surprisingly found in an experimental procedure that a volume of cleaning agent filled in the generator between 30 and 50 liters, in particular 40 liters, leads to the best cleaning results.

According to an embodiment, the method further comprises measuring a voltage at the generator, wherein the filling fresh cleaning agent into the generator is carried out only in case the measured voltage is lower than a given threshold, in particular zero.

By measuring the voltage at the generator upon completion of the cleaning process and dry out application, a short circuit in the generator caused by a cleaning agent filled into the generator is prevented.

Additionally, and/or alternatively, a further aspect is disclosed, and/or in particular as an embodiment of one of a precedingly described aspect and/or embodiments, namely, a method for operating a wind turbine, in particular an offshore wind turbine, further in particular a floating offshore wind turbine, and/or for feeding electrical and/or chemical energy to an electricity and/or chemical grid, the method comprising the following steps:
executing steps of an embodiment or of a combination of embodiments of a method as disclosed supra, and/or operating an embodiment of a device as disclosed supra, generating, by the wind turbine, electrical power and/or electrical energy, and in particular generating at least partially from the electrical energy, further in particular, by transforming electrical energy into hydrogen by electrolysis, chemical energy in form of a gas or liquid, in particular in the form of hydrogen,
transmitting, at least partially, the electrical power, the electrical energy, and/or the chemical energy to an energy receiving arrangement, in particular wherein the receiving arrangement is not positioned in international waters, is positioned onshore, and/or is positioned within a 12-miles-zone of a respective sovereign national state over which the respective state has jurisdiction, and supplying, at least partially, the electrical power, the electrical energy, and/or the chemical energy to an electrical and/or chemical utility grid, in particular to an onshore electrical and/or chemical utility grid and/or chemical/electrical storage.

The term “chemical energy” includes means for storing energy in a chemical substance such as in hydrogen. A chemical energy grid could for example be a gas (hydrogen) grid and/or storage device.

According to a third aspect, embodiments of the present invention relate to the use of a cleaning fluid, in particular a grease remover, for cleaning a wind turbine, in particular a generator of a wind turbine.

It has surprisingly been found that a cleaning fluid, in particular a large amount of a cleaning fluid, such as a grease remover, can be used for cleaning a generator in a wind turbine.

According to a fourth aspect, embodiments of the present invention relate to a wind turbine for generating electrical energy, comprising a tower, a nacelle and/or bedframe rotatably mounted to the tower, a rotor with at least one rotor blade, the rotor being rotatably mounted to the nacelle and/or bedframe around an essentially horizontal axis, and an electric generator drivable by the rotor, wherein the wind turbine is cleaned by an embodiment of the method disclosed herein.

According to a fifth aspect, embodiments of the present invention relate to a wind turbine for generating electrical energy, comprising a tower, a nacelle and/or bedframe rotatably mounted to the tower, a rotor with at least one rotor blade, the rotor being rotatably mounted to the nacelle and/or bedframe around an essentially horizontal axis, and an electric generator drivable by the rotor, wherein the generator is filled with a cleaning agent having a grease remover, and wherein the grease remover has a density larger than 0.5 g/cm³, and/or lower than 0.9 g/cm³, and/or has kinematic viscosity larger than 1.0 mm²/s, and/or lower than 3.0 mm²/s, and/or wherein the grease remover is a non-waters-soluble and is a fluid liquid such that the generator of the wind turbine can be flushed with the grease remover, has a density larger than 0.6 g/cm³, larger than 0.7 g/cm³, larger than 0.75 g/cm³, and/or lower than 0.85 g/cm³, lower than 0.82 g/cm³, lower than 0.8 g/cm³, and/or wherein the density is essentially 0.77 g/cm³, has kinematic viscosity larger than 1.3 mm²/s, larger than 1.5 mm²/s, larger than 1.8 mm²/s, and/or lower than 2.5 mm²/s, lower than 2.0 mm²/s, lower than 1.9 mm²/s, and/or wherein the kinematic viscosity is essentially 1.88 mm²/s, and/or comprises N-Paraffins, hydrocarbons, aliphatic hydrocarbons, mechanical components, such as abrasives and chemical components, such as bipolar chains, and/or a binder.

### BRIEF DESCRIPTION

Some of the embodiments will be described in detail, with references to the following Figures, wherein like designations denote like members, wherein:

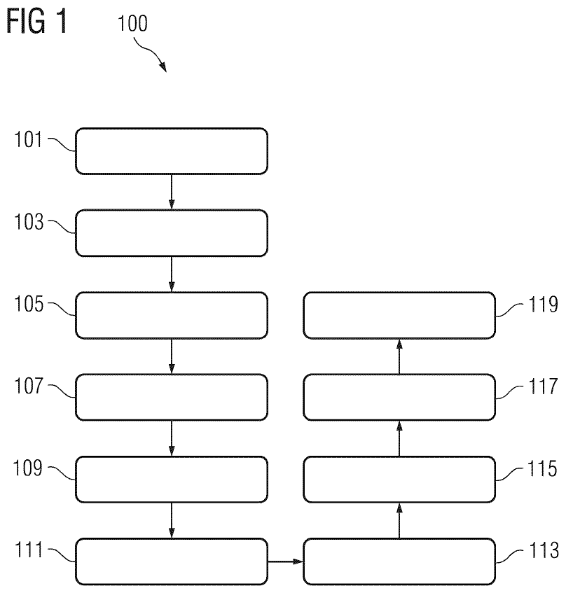

FIG. 1 shows a method for cleaning a generator in a wind turbine, according to an embodiment;

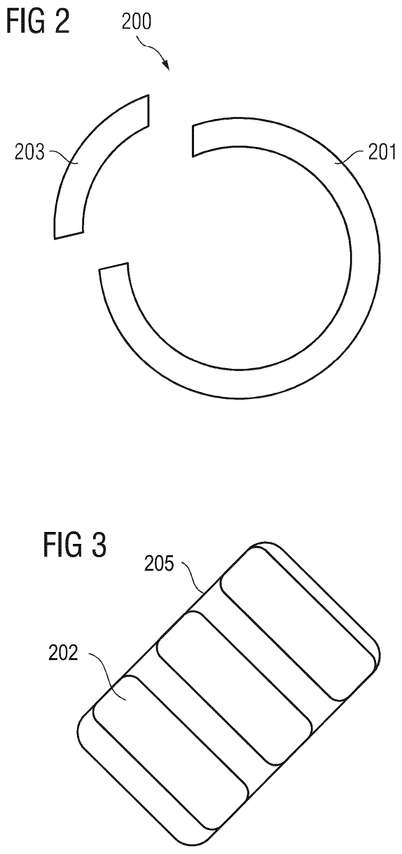

FIG. 2 shows a stator of a generator for a wind turbine consisting of a plurality of segments;

FIG. 3 shows a segment of the stator according to FIG. 1 in detail; and

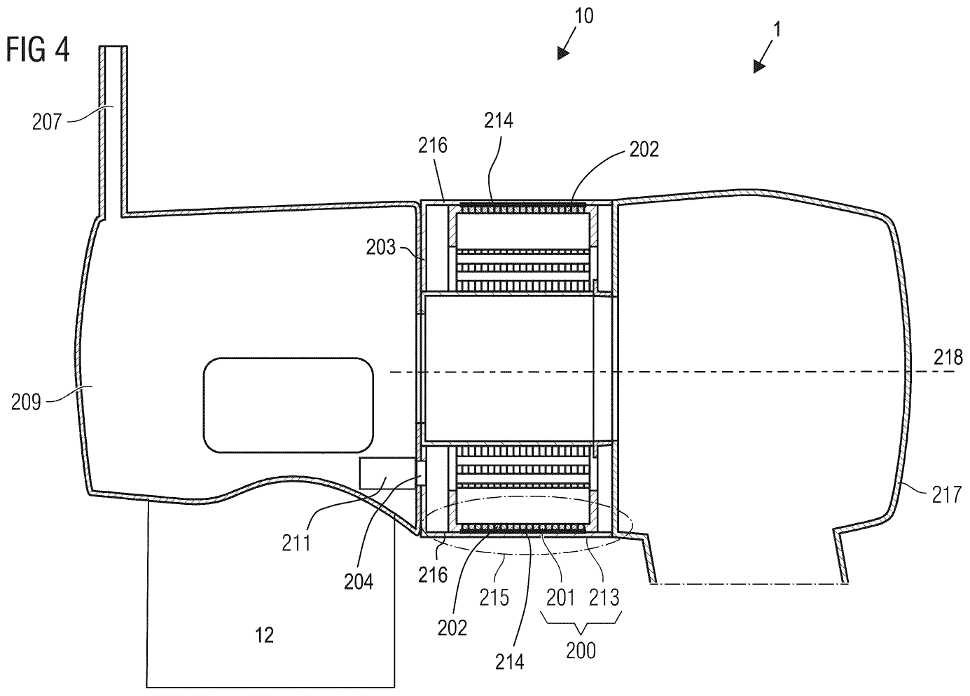

FIG. 4 shows a nacelle of a wind turbine with a generator.

### DETAILED DESCRIPTION

FIG. 1 shows a method 100 for cleaning a generator in a wind turbine.

The method 100 comprises a locking step 101, in which a rotor of the wind turbine is locked up, a shutting-off step 103, in which the generator is shut off, a filling step 105, in which fresh cleaning agent is filled into a segment of the generator, a removal step 107 in which the cleaning is removed or at least partially removed from the segment of the generator, a releasing step 109, in which the rotor is released and a moving step 111, in which the rotor is locked up again, a removal step 113, in which the contaminated cleaning agent is removed from the generator, a second releasing step 115, in which the rotor is released again, and a starting step 117, in which the generator is started.

The method 100 further comprises continuing by cleaning another portion of the generator rotor, wherein cleaning the other segment comprises a locking step 113, in which the rotor is locked again, an insertion step 115, in which a cleaning agent is filled into the generator, and a removal step 117, in which the cleaning is removed or at least partially removed from the generator.

In some embodiments, the method 100 comprises an analysis step 119, in which the removed and contaminated cleaning agent is analyzed with respect to a criterion specifying the grade of contamination of the cleaning agent, and in case the grade of contamination is greater than a given threshold, the filling step 105 and the removal step 107, are repeated until the grade of contamination is less or equal to the threshold.

FIG. 2 shows a stator 201 of a generator for a wind turbine comprising a plurality of portions 203.

In an exemplary wind turbine (FIG. 4), a nacelle 207 is equipped with a generator 200, wherein a wind turbine rotor 217 of the wind turbine 1 is rotatable supported by the nacelle 207 such that a rotatable portion of the generator 200 can be rotated by the wind turbine rotor 217. In the exemplary case the rotatable portion of the generator 200 is referred to as the generator rotor 213 of the generator 200, wherein a non-rotating portion of the generator 200 may be referred to as the stator 201. It is apparent for the skilled person that the use of the terms “stator” and “rotor of the generator” shall not limit the scope of embodiments of the present invention. Specifically, any alternative configuration of a generator having a rotatable generator-rotor and a non-rotating data is included in the scope.

According to this embodiment, the generator rotor 213 comprises a rotating portion of the housing (rotating housing 216) and magnetic elements 214. Both are connected for rotation with the wind turbine rotor 217.

According to the exemplary wind turbine, the housing of the rotor 217 of the wind turbine (or the hub of the rotor 217) encompasses also the generator 200, thereby, forming also a housing of the generator 200. Specifically, the housing of the generator 200 comprises a fixed housing 203 being primarily located on the axial side of the generator adjacent to the nacelle 207. The fixed housing 203 comprises an opening 204. A cooling device drowned 11 is mounted on the opening 204 such, that air, for example from the inside of the nacelle 207, can be blown by the cooling device in an inner volume of the generator 200.

The opening 204 is identified as being a suitable entry point for in searching the cleaning agent into the generator 200.

Since a space between the stator 201 and the taking housing of the generator 200 is very small (5 to 8 mm), the windings 202 of the stator 201 cannot be reached by a cleaning apparatus, such as a brush, for example.

In FIG. 3, a segment 205 of the stator 201 is shown in detail. The segment 205 includes numerous windings 202 which are hard to access by mechanical apparatuses. Thus, the segment 205 is hard to clean.

Further, grease from bearings of the wind turbine accumulates between the windings during operation of the wind turbine, thereby causing both thermal and electrical problems.

In FIG. 4, the nacelle 207 of a wind turbine is shown. The nacelle 207 includes a backend 209 in which auxiliary units such as a cooling system 211 are located, a rotor 217 of the wind turbine forming a rotating housing 216 of the rotor 213 of a generator 200 including a stator 201.

A circle 215 marks a volume between the stator 201 and the housing of the generator rotor 213, which cannot be reached by cleaning apparatuses from outside the generator 200.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.
1 wind turbine
200 generator
201 stator
202 winding patent
203 fixed housing
204 opening
205 segment
207 nacelle
209 backend
211 cooling device
213 generator rotor
214 magnetic elements
215 circle
216 rotating housing
217 wind turbine rotor
218 horizontal rotational axis

1. A method for cleaning a generator of a wind turbine, wherein the wind turbine comprises a tower, a nacelle rotatably mounted to the tower, a wind turbine rotor with at least one rotor blade, the wind turbine rotor being rotatably mounted to the nacelle around an essentially horizontal rotational axis, and an electric generator drivable by the wind turbine rotor, the electric generator including a fixed housing and a rotating housing, a generator rotor having magnetic elements, a stator having windings, and a cooling device attached to an opening of the fixed housing, the method comprising:
locking the wind turbine rotor and shutting off the electric generator;
removing the cooling device such that the opening is accessible for maintenance purposes;
inserting a cleaning agent into the opening such that the cleaning agent gets at least partially in effective contact with a winding and/or with a magnetic element;
at least partially removing the cleaning agent from the electric generator;
mounting the cooling device to the opening; and
releasing the wind turbine rotor,
wherein the cleaning agent is or comprises a grease remover, and wherein the grease remover is non-water-soluble and is a fluid liquid such that the electric generator of the wind turbine can be partially flushed with the grease remover, has a density larger than 0.6 g/cm³ and lower than 0.85 g/cm³, has a kinematic viscosity larger than 1.3 mm²/s and lower than 2.5 mm²/s, and comprises N-Paraffins and hydrocarbons.

2. The method according to claim 1,
wherein the grease remover has a density larger than 0.7 g/cm³, and lower than 0.82 g/cm³, or of essentially 0.77 g/cm³,
and wherein the grease remover has a kinematic viscosity larger than 1.5 mm²/s, and lower than 2.5 mm²/s, or of essentially 1.88 mm²/s.

3. The method according to claim 1,
wherein the removed cleaning agent is analyzed with respect to a criterion specifying a grade of contamination of the cleaning agent, and
in case the grade of contamination is greater than a given threshold, the following steps are repeated until the grade of contamination is less or equal to the given threshold:
inserting a cleaning agent into the opening such that the cleaning agent gets at least partially in effective contact with the winding and/or with the magnetic element;
at least partially removing the cleaning agent from the electric generator.

4. The method according to claim 3, wherein the criterion comprises a reference color.

5. The method according to claim 1, further comprising:
shutting off the cooling device for cooling the electric generator before filling fresh cleaning agent into the electric generator, and
starting the cooling device before starting the electric generator for drying the electric generator from the cleaning agent.

6. The method according to claim 1, wherein removing the contaminated cleaning agent from the generator comprises:
lowering a suction hose into the electric generator, and
sucking out the contaminated cleaning agent using a pump.

7. The method according to claim 1, wherein a volume of cleaning agent filled in the electric generator is between 10 and 50 liters.

8. The method according to claim 1, comprising:
measuring a voltage at the electric generator, and
wherein the filling fresh cleaning agent into the electric generator is carried out only in case the voltage is lower than a given threshold and/or is essentially zero volt.

9. A method for operating a wind turbine, and/or for feeding electrical energy to an electricity grid, the method comprising:
cleaning a generator of the wind turbine according to claim 1;
generating, by the wind turbine, electrical power and/or electrical energy;
transmitting, at least partially, the electrical power and/or the electrical energy to an energy receiving arrangement, wherein the receiving arrangement is not positioned in international waters, is positioned onshore, and/or is positioned within a 12-mile-zone of a respective sovereign national state over which the respective state has jurisdiction; and
supplying, at least partially, the electrical power and/or the electrical energy to an onshore electrical utility grid.

10. A wind turbine comprising a tower, a nacelle rotatably mounted to the tower, a wind turbine rotor with at least one rotor blade, the wind turbine rotor being rotatably mounted to the nacelle around an essentially horizontal rotational axis, and an electric generator drivable by the wind turbine rotor,
wherein the electric generator comprises a fixed housing and a rotating housing, a generator rotor having magnetic elements, a stator having windings, and a cooling device attached to an opening of the fixed housing,
wherein the electric generator is cleaned by conducting a cleaning method according to claim 1.

11. A wind turbine comprising a tower, a nacelle rotatably mounted to the tower, a wind turbine rotor with at least one rotor blade, the wind turbine rotor being rotatably mounted to the nacelle around an essentially horizontal rotational axis, and an electric generator drivable by the wind turbine rotor,
wherein the electric generator comprises a fixed housing and a rotating housing, a generator rotor having magnetic elements, a stator having windings, and a cooling device attached to an opening of the fixed housing,
wherein a cleaning agent or remains of a cleaning agent is/are present within the electric generator after conducting a cleaning method according to claim 1, and
wherein the cleaning agent or remains of a cleaning agent comprise/s a grease remover, wherein the grease remover is non-water-soluble and is a fluid liquid such that the electric generator of the wind turbine can be partially flushed with the grease remover, has a density larger than 0.6 g/cm³ and lower than 0.85 g/cm³, has kinematic viscosity larger than 1.3 mm²/s and lower than 2.5 mm²/s, and comprises N-Paraffins and hydrocarbons.

12. The wind turbine according to claim 11, wherein the grease remover has a density larger than 0.7 g/cm³, and lower than 0.82 g/cm³, or of essentially 0.77 g/cm³, and
wherein the grease remover has a kinematic viscosity larger than 1.5 mm²/s, and lower than 2.5 mm²/s, or of essentially 1.88 mm²/s.

13. A method comprising utilizing a cleaning agent for cleaning a winding and/or a magnetic element of a generator of a wind turbine, wherein the cleaning agent is having a grease remover, and wherein the grease remover is non-water-soluble, and
is a fluid liquid such that the generator of the wind turbine can be flushed with the grease remover, and
has a density larger than 0.6 g/cm³ and lower than 0.85 g/cm³, and
has kinematic viscosity larger than 1.3 mm²/s and lower than 2.5 mm²/s, and comprises N-Paraffins and hydrocarbons.

14. The method comprising utilizing the cleaning agent according to claim 13,
wherein the grease remover has a density larger than 0.7 g/cm³, and lower than 0.82 g/cm³, or of essentially 0.77 g/cm³,
and wherein the grease remover has a kinematic viscosity larger than 1.5 mm²/s, and lower than 2.5 mm²/s, or of essentially 1.88 mm²/s.
